(19) United States
(12) Patent Application Publication
(10) Pub. No.: US 2021/0277284 A1
(43) Pub. Date: Sep. 9, 2021

(54) MULTI-LAYER, OPTICALLY CLEAR ADHESIVES WITH SLIP LAYER

(71) Applicant: 3M INNOVATIVE PROPERTIES COMPANY, St.Paul, MN (US)

(72) Inventors: Albert I. Everaerts, Tucson, AZ (US); Karen J. Calverley, Stillwater, MN (US)

(21) Appl. No.: 16/324,946

(22) PCT Filed: Aug. 10, 2017
(86) PCT No.: PCT/US2017/046189

§ 371 Date: Feb. 12, 2019

Related U.S. Application Data
(60) Provisional application No. 62/375,522, filed on Aug. 16, 2016.

(51) Int. Cl. C09J 7/25; C09J 7/38; C09J 7/40

(52) U.S. Cl. CPC C09J 7/255; C09J 7/385; C09J 7/401; C09J 2301/312; C09J 2433/00; C09J 2301/208; C09J 2301/1242; C09J 2203/318; C09J 2301/302

(57) ABSTRACT

The present invention is a multi-layer optically clear adhesive construction having at least one adhesive slip layer. Exemplary constructions comprise an adhesive core layer and at least one slip layer. The slip layer provides enhanced reworkability of the final assembly and also alleviates bonding process induced stress. The slip layer is represented by a curable adhesive layer having a tan delta of at least 0.8 at a temperature of 100° C. at 1 Hz. The adhesives described herein may be used in display assemblies to provide optical and mechanical coupling of substrates in the device.

### FIELD OF THE INVENTION

The present invention is related generally to the field of optically clear adhesives. In particular, the present invention is a multi-layer optically clear adhesive construction having at least one adhesive slip layer.

### BACKGROUND

Optically clear adhesives (OCAs) are commonly used in display assemblies to provide optical and mechanical coupling of the substrates to enhance brightness, improve contrast, and enhance durability of the device. Current OCAs are generally provided in one of two forms: one is a liquid, optically clear adhesive (LOCA) and the other is a film sold as a roll good or as a die cut.

Display assemblies are typically comprised of multiple components which are in part optically and mechanically bonded together with OCAs. FIG. 1 shows an LCD module 100 having a cover lens 130, an LCD module 110 and several OCA layers 112 bonding together various components of the construction. An ink step 102 is shown atop the LCD module at its periphery, with OCA layer 112 filling the spaces around the ink step and bonding the LCD module to the adjacent layer. Alternatively, such ink step may also be positioned at the bottom of the cover lens 130. An ink step refers to the height of an ink boarder often placed at the peripheral edge of a display.

Common display assembly constructions require these OCAs to be positioned between an ink-step printed cover lens and a touch sensor, a touch sensor and a display module (for example an LCD or OLED), or both. The OCA may also have to be compatible with bare indium tin oxide (ITO) 118 and/or metal traces of the integrating circuits which may be coated on a film substrate 119. In addition, OCA use between the LCD and touch panel requires Mura-free lamination (i.e., lamination without creating optical defects and distortions.). The higher compliance required for the ink step coverage and the Mura-free lamination to the LCD continues to create OCA design and application challenges. Because both solid and liquid OCAs are not compressible, their lamination between two substrates can create significant stress. In solid form, this stress may be slow to decay, while in liquid form, the stress may dissipate quickly just to be replaced by curing shrinkage induced stress. Ideally, OCAs would be flowable and soft, while also providing high adhesion and durability. The latter two typically require a higher stiffness or modulus and a reduction or elimination of flow. In addition, once the assembly is made, it may be desirable to have some level of reworkability so that defective panels can be recovered and refurbished. A common technique to do so is the use of wire cutting, followed by adhesive residue removal from the panels.

A particular challenge with the wire cutting process is to be able to accurately guide a thin wire through the bond line without introducing excessive force that could break the wire, while also not dragging the wire over the substrate to be recovered so surface damage can be avoided. Once the cut is made, the adhesive residue should be cohesive enough for stretch removal to be used or at least a clean peel to be obtained after, if necessary a supporting backing is applied to the residue. Thus, it can be advantageous to have a weak cohesive OCA layer positioned on one or both sides of a more cohesive core (adhesive or not, but optically clear or optically active) to form a multi-layer tape construction. In such cases, a wire may be preferentially guided through the less cohesive layer because it is difficult to penetrate the more cohesive core layer. After wire cutting, the more cohesive core layer can also facilitate removal of the tape residue.

It is currently still challenging to strike the right combination of properties, with most liquids having good flow for assembly but limited adhesive strength, while the single layer adhesives provide either high adhesion with high crosslink density and thus are not very flowable, or, they can be made more flowable and curable to high bond strength, but these products may cause excessive adhesive drag on the wire potentially causing it to break and they may show only moderate cohesive strength after curing, making adhesive residue removal challenging.

In addition, in more recent applications related to bent displays (such as an OLED display positioned against a cover lens having permanently bent edges on opposite ends of the lens) or the emerging flexible displays, it may be desirable to minimize or ideally eliminate the lamination induced stress that can cause excessive strain on the OLED and damage it. This can be a significant issue if the display stack components (for example cover window, touch panel, circular polarizer, etc.) are laminated to the OLED panel in a flat format to be shaped later into its final bent shape. Liquid optically clear adhesives may be used here to minimize the assembly stress but they may be difficult to handle due to squeeze-out and leakage prior to curing. In contrast film type OCAs are easier to work with but due to their typical nature of being higher molecular weight, at least partially crosslinked, or very high in viscosity they can generate and trap assembly stress for a long time to cause excessive strain on the OLED panel.

### SUMMARY

In one embodiment, the present invention is an article including a core adhesive layer having a first surface and a second surface and a first curable adhesive layer positioned adjacent the first surface of the core adhesive layer. Both the core adhesive layer and the first curable adhesive layer are optically clear. The first curable adhesive layer has a tan delta of at least 0.8 at a temperature of 100° C. at 1 Hz.

### BRIEF DESCRIPTION OF THE DRAWINGS

These figures are not drawn to scale and are intended merely for illustrative purposes.

FIG. 1 is a cross-sectional view of a prior art construction of a display assembly.

FIG. 2 is a cross-sectional view of a single slip layer construction of the present invention.

FIG. 3 is a cross-sectional view of a double slip layer construction of the present invention.

FIG. 4 is a cross-sectional view depicting a construction lacking a slip layer prior to and after compression of an OCA.

FIG. 5 is a cross-sectional view depicting a construction having a slip layer prior to and after compression of the OCA.

FIG. 6 depicts ink step test coupons in exemplary embodiments of the disclosure.

FIG. 7 depicts an ink step coupon laminate cross-section in an exemplary embodiment of the disclosure.

### DETAILED DESCRIPTION

The present invention is a multi-layer, optically clear adhesive (OCA) containing construction including a core layer and at least one adhesive slip layer. The construction is positioned between two substrates. The presence of an adhesive slip layer provides the unique benefit of quickly alleviating bonding process induced stress, enhancing ink-step filling behavior of the tape or die cut, and reducing the so-called bright line defect (i.e., a line with much higher light intensity than the main part of the display) resulting from the mechanical distortion of a film sensor applied over an ink-step printed lens. The application of at least one adhesive slip layer on a more cohesive core layer also allows for easier die-cutting (vs. slip layer adhesive only) and provides enhanced reworkability of the final assembly. In some embodiments, an adhesive slip layer is present on both sides of the construction, so that an adhesive slip-layer is in contact with the two substrates to be assembled.

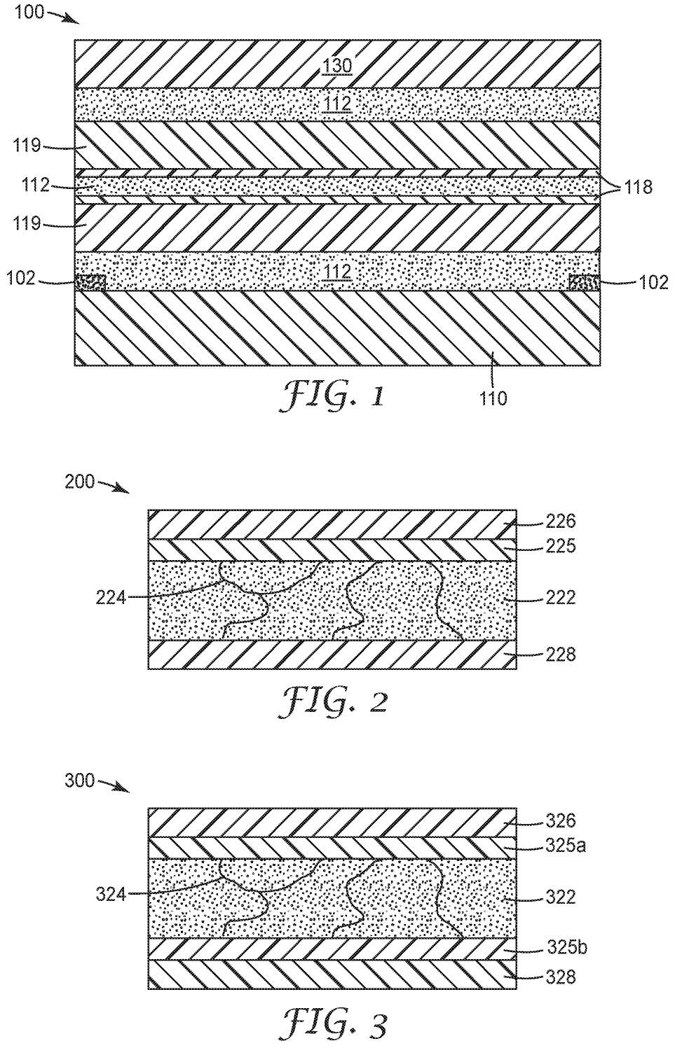

FIG. 2 is a cross-sectional view of a first construction 200 of the present invention. The first construction 200 includes a core OCA layer 222, an adhesive slip layer 225, a first release liner 226 and a second release liner 228. The adhesive slip-layer 225 can be laminated to, coated onto, or simultaneously coated with the core layer 222. Alternatively, the adhesive slip layer 225 can be laminated between the substrate 226 and the core layer 222 during device assembly. In some cases, the core layer 222 can be the same as a substrate (for example a polarizer or plastic touch sensor).

The core layer 222, in general, may be either an optically clear and passive layer, or an optically active layer (i.e. to include functionality to diffuse, diffract, color-shift or otherwise affect the light). In some examples, the core layer 222 partially contains a crosslinked polymer fraction 224 and is an optically clear adhesive or an optically clear film. The optically clear core layer 222 may optionally contain additional coatings, such as, for example, an electro-conductive coating on an optically clear film to make a touch sensor. An example of an optically active film may be a polarizer or color filter.

The adhesive slip layer 225 is defined as an optically clear adhesive that is typically an incompressible solid but is not crosslinked. Two types of adhesive layers are found useful including pressure-sensitive adhesives and heat-activated adhesives. The difference between these related materials is found in their glass transition temperature (Tg). Heat-activated adhesives have a glass transition temperature that is higher than room temperature whereas pressure-sensitive adhesives have a glass transition temperature that is below room temperature. When heating heat-activated adhesives to a temperature at or higher than their Tg, the adhesive modulus drops to where it becomes tacky and bondable. Upon cooling the heat-activated adhesive, the tack may be lost but the bond is retained. In contrast, since pressure-sensitive adhesives at ambient temperature are above their Tg and have a low storage modulus (i.e. they meet the well-known Dahlquist criterion for tack), they are permanently tacky and bondable at such temperature.

It is potentially beneficial in some applications to further include additives like pigments or dyes, or light scattering particles to tune the optical properties of the base adhesive material.

The adhesive slip layer 225 has the potential to be displaced in the x-y plane when a compressive force is applied in the z-direction during assembly. Unlike crosslinked adhesives, the adhesive slip layer has no significant elastic memory and thus does not recoil when the z-direction assembly force is removed. Being positioned against the core layer 222, the adhesive slip layer 225 in essence allows slip between the core layer 222 and the first substrate 226. By this means, the adhesive slip layer 225 functions to allow bonding stress to be minimized and any residual bonding stress to be rapidly dissipated. When positioned near an ink step, side-ways displacement of the adhesive slip layer also facilitates filling of the sharp, inner ink step corner. Adhesive layers with lower viscosity are generally favored because they may generate less stress and allow faster stress dissipation.

FIG. 3 is a cross-sectional view of a second construction 300 of the present invention. This second construction 300 includes a core OCA layer 322, two adhesive slip layers 325a and 325b, a first release liner 326, and a second release liner 328. The core layer 322 contains a crosslinked portion 324. The adhesive slip layers 325a and 325b can be laminated to, coated onto, or simultaneously coated with the core layer 322. Alternatively, the slip layers 325a and 325b can be laminated between the substrates 326, 328 and the core layer 322 during device assembly. In some cases, the core layer 322 can be the same as a substrate (for example a polarizer or plastic touch sensor). The construction of FIG. 3 having two slip layers provides added workability such that one substrate or the other can be easily repositioned during assembly.

The viscosity or viscous behavior of the adhesive materials can be reflected in the rheology metric commonly known as the tan delta of the material. Typically, a material with a higher tan delta value at a given temperature has a higher viscous component (reflected in the shear loss modulus G″) and a lower elastic component (reflected in the shear storage modulus G′) for that temperature. The tan delta of interest for a given slip layer of this invention is commonly measured at elevated temperatures (i.e. at temperatures above the Tg of the adhesive, where the tan delta value also goes through a maximum value) using dynamic mechanical analysis (DMA) equipment at 1 Hz frequency. For the non-crosslinked adhesive, the measured values for tan delta commonly increase as temperature increases beyond the Tg transition. In general for a slip layer adhesive with lower viscosity, this tan delta increases faster and to higher values for a given temperature, whereas for a higher viscosity slip layer adhesive this increase may be slower and to lower values for a given temperature. In general, a bonding assembly process requires a slip layer with a tan delta of at least 0.8 (DMA at 1 Hz and 100° C.). More particularly, the bonding assembly process requires a slip layer with a tan delta of at least about 1.0 (DMA at 1 Hz and 100° C.). Most particularly, the bonding assembly process requires a slip layer with a tan delta of at least about 1.5 (DMA at 1 Hz and 100° C.). Higher values for tan delta (indicative of the fluidity of the adhesive) provide for better flow of the material during bonding assembly, but issues related to flow, creep and oozing of the material set practical limits to the tan delta of the materials in the process. If flow, creep, and oozing need to be controlled it may be beneficial to partially cure the slip layer prior to shipping of the multi-layer material or its use in the lamination process. In such cases, it may still be beneficial to keep a tan delta of at least about 0.8 (measured at 100° C. and a frequency of 1 Hz) after partial crosslinking is complete.

An example of the slip layer OCA is a UV crosslinkable acrylate adhesive which can be a hot melt or solvent coat, such as those described in 3M patent application docket number 71129US003. These OCAs can be laminated, for example, against one or both sides of a typical, already (partially) crosslinked OCA or an optically clear film backing, such as a polyester (polyethylene terephthalate (PET—Skyrol SH 81 from SKC, Korea), polyethylene naphtalate (PEN), etc.), a cyclic-olefin copolymer (COP—Zeonor 1020R from Zeon Chemicals, Louisville, Ky.), a metallocene polyolefin such as those used in stretch releasable adhesive tape, a block copolymer derived film, etc. Likewise, these un-crosslinked OCAs can be applied against a conventional, already crosslinked OCA, such as 3M's commercial 8180, 8260, 8146 type adhesives, CEF28xx, CEF29xx, etc. (3M Company, St. Paul, Minn.). In one embodiment, the core layer is a softer, lower modulus material, so the total tape compression hardness is reduced. For this reason, OCA layers are typically preferred over film core layers. The un-crosslinked slip-layer adhesives may (optionally) be cured (i.e. crosslinked) after assembly as is the typical process to provide a durable display. Curing can be achieved using any of a number of well-known techniques from the art, including radiation curing, thermal curing, moisture-curing, etc. Radiation curing and, in particular, UV curing are currently most common in the display assembly industry.

Without wishing to be bound by theory, it is thought that the application of an adhesive will establish a strong surface contact footprint on the substrate quickly. This is true for either crosslinked single layer adhesives or multi-layered adhesives where the skin layer(s) are already crosslinked. Once that surface contact footprint is made, it is very difficult to break. As a result, any additional deformation of the single or multi-layer adhesive can cause stress to be trapped. For example, this can be true when conforming to an ink step in conventional processes. In this case, the adhesive may typically first make contact on both sides of the ink step and then needs to stretch to push into the corner of the step. Because conventional processes and OCAs do not allow slip at the adhesive/substrate interface, the inherently trapped stress can cause unacceptable bubbles (known in the industry as delayed bubbles) to form. Another common conventional process involves first bonding two film substrates together with an OCA (in the flat state) and then bending the laminate. In this conventional process, a significant shear stress can be generated between the two substrates and strain can be transferred to and between the substrates. By enabling slip in the adhesive layer, the present invention mitigates this bending stress and thus also the strain. For durability reasons, once the final bent shape is obtained, the OCA is typically cured and slippage reduced or eliminated.

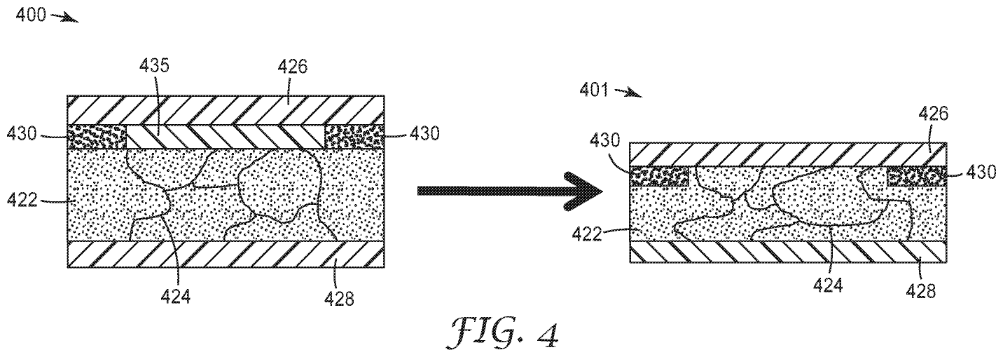

FIG. 4 is a cross-sectional view of a third construction of the present invention wherein slip layers are not utilized. This third construction includes a core OCA layer 422, a first substrate 426 and a second substrate 428. The core layer 422 contains a crosslinked portion 424. An ink step 430 is shown adjacent to one of the substrates 426. In a first position 400, the construction is shown prior to deformation with an air gap 435 prior to wetting or filling with the core layer 422. In a second position 401, the construction is compressed and the core layer 422 fills the air gap.

As seen in FIG. 4, for a regular core layer 422, the networked chains 424 of the adhesive will span through the thickness of the layer. Thus, once a conventional OCA is laminated and compressed, the polymer network chains 424 have no choice but to deform. This adhesive deformation resulting from (e.g.) trying to push the adhesive into a corner of an ink step may still cause the network of chains 424 to stretch. This deformation and stretching creates stress and a driving force to pull back.

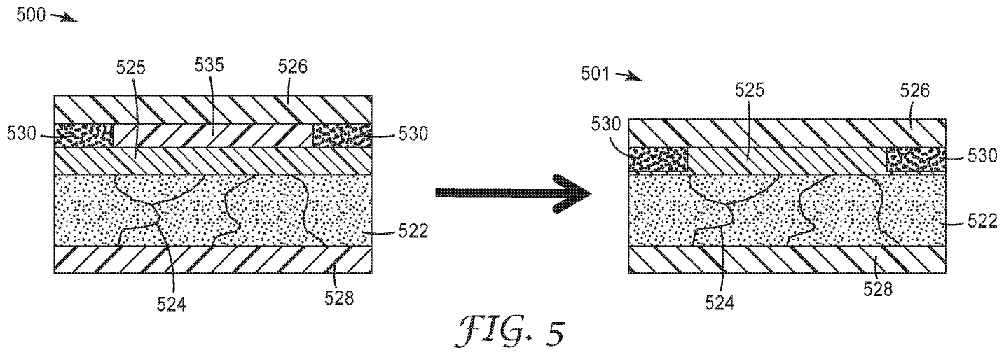

FIG. 5 is a cross-sectional view of a fourth construction of the present invention showing how a slip layer 525 aids in the assembly of the device. In a first position 500, the fourth construction includes a core OCA layer 522, a first substrate 526, and a second substrate 528. The core layer 522 contains a crosslinked portion 524. An ink step 530 is shown adjacent to one of the substrates 526. In some cases, the core layer 522 can be the same as a substrate (for example a polarizer or plastic touch sensor). In a first position 500, the construction is shown prior to deformation with an air gap 535 prior to wetting or filling with the core layer 522. In a second position 501, the construction is compressed and the core layer 522 fills the air gap.

As seen in FIG. 5, the current invention proposes a slip layer 525 such that the crosslinked chains of an OCA core layer 522 cannot make direct contact with the substrate 526. If a slip layer were to be used on the substrate 528 side as well, contact between the crosslinked core layer 522 would also be prevented. By this means, the substrate(s) 526, 528 can slide back and forth on this slip boundary to alleviate any stress. By means of this invention, most, if not all, of the deformation happens in the slip layer 525 so that the core layer 522 remains essentially stress-free. Being flowable, the slip layer 525 itself also relieves the lamination stress very quickly. Once the assembly is made, the slip layer 525 can be cured (i.e. crosslinked) and “set” to provide higher cohesive strength and higher durability of the finished assembly.

In general, it is desirable to minimize excessive material from squeezing out during the bonding assembly process. To minimize excessive slip layer material from squeezing out during the bonding process, it may be beneficial to keep the slip layer thin. The common thickness for the slip layer ranges from as little as a few microns and as high as about 50 microns. The desirable thickness ranges for the slip layers is dependent on the construction requirement for the final article. In one example application, a layer of about 50 microns or even slightly higher may be required to provide adequate filling of the conventional ink step, but for thicker layers, excessive material squeeze-out may result. Exploring the other end of the functional thickness range, thicknesses less than a few microns may be sufficient for a slip layer, but when the layer becomes too thin, the risk of premature contact between the more cohesive core layer and the substrate increases. In addition, when an ink step is to be covered, a few microns of slip layer may be insufficient to fill the gap adjacent to the ink step and residual air may be trapped. In another example application, when applying different layers (for example: cover window, touch sensor, or circular polarizer) with OCAs to an OLED to be shaped into a curved or bent display, a slip layer thickness of a micron or even less may be acceptable as it may still be sufficient to relieve lamination and shape forming induced stresses that can cause damage to the OLED structure.

If desired, slip behavior can be further enhanced by slightly heating the OCA construction during lamination, but in general, this step is not required. In some cases, a heat activated slip layer may provide additional benefit. For instance, because of the low tackiness, the positioning and repositioning of the adhesive on the substrate can be easier. With little or no heat applied during assembly, the ultimate bond strength is also not obtained, so rework can also more easily be done prior to full heat activation.

### Examples

The present invention is more particularly described in the following examples that are intended as illustrations only, since numerous modifications and variations within the scope of the present invention will be apparent to those skilled in the art. Unless otherwise noted, all parts, percentages, and ratios reported in the following example are on a weight basis.

In the tables, “NA” means not applicable.

### Test Methods and Preparation Procedures

### Test Coupon Preparation Procedures

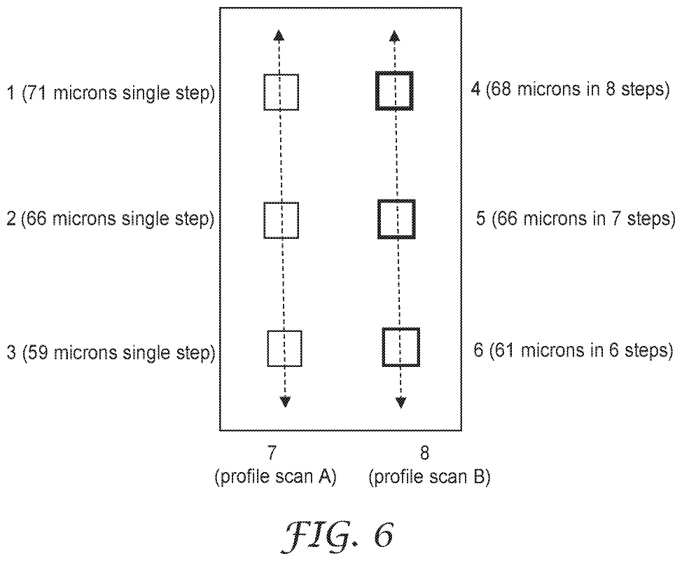

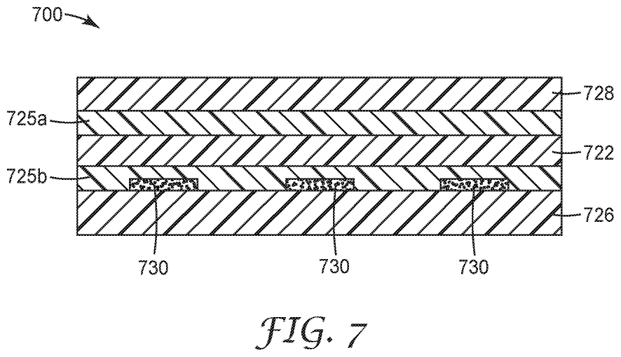

In order to check on the possible advantages of using a slip layer for laminating to a printed cover glass, test coupons were designed having a variety of types of ink steps. FIG. 6 shows the six types of ink steps in plain view for a representative test coupon glass substrate. These test coupon substrates are then over laminated with example OCA tapes for comparison of results that will be described in the tests below. The six types of ink steps provided for each comparison test coupon include: (1) single step of 71 micron height, (2) single step of 66 micron height, (3) single step of 59 micron height, (4) 68 micron ink height in 8 equal stair-steps, (5) 66 micron ink height in 7 equal stair-steps, and (6) 61 micron ink height in 6 equal stair-steps. Each ink patch was 2 cm long and wide.

FIG. 7 shows a cross-sectional schematic view of the test coupons which were fabricated for comparison. The test coupon substrate bearing the pattern of ink steps is laminated with a film layer bearing an OCA stack as described in the Table 1 below.

As can be seen in construction 700 of FIG. 7, there may be two slip-layers 725a, 725b facing both sides of a core OCA layer 722. Similar to other constructions described herein, the device of FIG. 7 further included ink steps 730 atop glass substrate 726, and a second, opposing film substrate 728.

For some of the samples that follow, there was only one slip layer positioned either between the core and test coupon substrate or between the core and film layer used in the lamination test. These variations and resulting measurements of lamination quality should be evident from the sample construction table which follows.

### OCA Tape/Coupon Lamination:

Examples and comparatives were designed to maintain 6 mils total thickness for the core and slip layer(s) (if used) combined. The core OCA was either the non-UV curable, rigid type (3M commercial 8146) or the partially crosslinked and UV curable, somewhat softer type (3M commercial CEF28xx). The OCA tape (core and slip layer(s)) were first laminated to the film layer (COP or PET) using one pass of a hand roller. This OCA tape/film construction was then applied to the test coupon at room temperature using the same one pass of a hand roller. After the OCA tape is applied to test coupon, the total construction was put in an autoclave at 60 degrees C. with 5 kg/cm² pressure for 30 minutes. The autoclave step was used to eliminate air bubbles introduced during roller lamination. After the laminated coupons cooled to room temperature they were then cured without further delay using a Fusion D bulb generating a UVA dose of 3 J/cm² so as to make them durable for environmental testing. Note that there was no additional pressing step prior to autoclaving or curing during our test panel assembly. A pressing step, while often not desired, may be used during actual production of displays with a film touch sensor. Such pressing step may be used to try to even out the distortion of the OCA and film around the ink step.

### Adhesive Creep Test

In order to determine the flow characteristics of the adhesives of this invention, the adhesive tapes were laminated with a 2.2 kg rubber-covered hand roller to a 50 micron thick polyester backing (Skyrol SH81 from SKC, Korea). A 1.5 cm wide strip was cut from the laminated sample and the release liner was removed. The same roller was used to apply the test strip to a stainless steel test panel. The overlap with the steel panel was reduced to 1.5 cm×2 cm, by trimming the length to 2 cm. A sufficient amount of tape was allowed to hang off the steel panel, so a 500 gram weight could be attached to the test strip. The weight was only applied after about 15 min dwell time between adhesive test strip and panel, so adhesion could built to secure the tape and thus avoid adhesive failure from the panel. The displacement of the top edge of the polyester backing relative to its original position was monitored for one hour after the sample was heated to 60 degrees C. and loaded with the 500 g weight. The distance in mm was recorded as creep displacement. This displacement reflects on the cohesive strength of the material because adhesive failure from the stainless steel test panel is not typically observed.

### Web Distortion Test Method

The slope of the plastic film over the ink step dictates the optical distortion or lensing of the transmitted light near the ink boundaries of a display device. The goal is to minimize any distortion of the film, which would also show up in an actual display device as a bright pattern near the ink edge. A Web Distortion Test Method was developed to give a comparative metric for the measuring how smoothly the film laminate responded to the six types of ink steps for the test coupons samples. This test method uses a conventional laser displacement sensor (available from Keyence corporation) to measure the distortion of the laser as it passed through the test coupon and gets redirected by the uneven OCA/film layers that occurred at the edges of the six types of ink steps of the test coupons. The Keyence sensor scans across the two rows on ink steps as shown in FIG. 6 to measure the leading and trailing slopes from the ink step test objects. The Keyence measured data is differentiated to get a measure of the physical slope (vertical rise/lateral run) and tabled in arbitrary units. A higher number means a higher slope, or more vertical rise over a shorter distance. The same laminated samples were also tested by projecting white light from a projector through the sample and observing the projected image on a screen. Samples with slope values of about 12,000 or more were deemed as unacceptable because they distort the transmitted light too much and the projected image shows a clear bright line; samples with slope values of less than 12,000 were deemed passable with lower values indicating better visual quality. Samples that passed both for the A slope and the B slope were clearly superior in performance as they work on either type of ink step. Those that pass only A slope or only B slope were acceptable but may work for one type of ink step design only. Those that passed neither the A of B slope failed. For consistency of the measurements across the comparison, each of the examples were always positioned for the Keyence measurement in the same orientation: with the film side towards the laser source and the largest ink step towards the upper right of the laser scan.

### Dynamic Mechanical Analysis

Dynamic mechanical analysis was used to probe the modulus as a function of temperature as well as to determine the tan delta of the material. An 8 mm diameter by about 1 mm thick disk of the adhesive was placed between the probes of a DHR parallel plate rheometer (TA Instruments, New Castle, Del.). A temperature scan was performed by ramping from −45° C. to 150° C. at 3° C./min. During this ramp, the samples were oscillated at a frequency of 1 Hz and a strain of approximately 0.4%. The shear storage modulus (G′) and shear loss modulus (G″) were recorded at selected key temperatures. The tan delta of the material was also determined as the ratio between loss and storage modulus (G″/G′) at any given temperature. The tan delta vs. temperature plot typically showed a tan delta maximum value at the Tg of the material and for a non-crosslinked material, the tan delta will eventually increase again at temperatures higher than Tg. The tan delta at this higher temperature is indicative of the flow of the slip layers used in this invention.

The preparation for the six types of slip adhesive utilized are detailed below:

### Adhesive 1

A 60/30/7/3 (weight %) 2-ethylhexylacrylate/n-butylacrylate/acrylamide/2-hydroxypropyl acrylate copolymer having an average of 2.91 isocyanatopropyl methacrylate (Karenz MOI available from Show Denko, Japan) groups per chain (already reacted with the hydroxy groups in the copolymer using the isocyanate group) and Mw (weight average molecular weight as measured by GPC against a polystyrene standard) of about 135,000 Dalton was solvent coated on a 3 mil siliconized release liner (RF02N from SKC Haas, Korea) using a notch bar set-up. This adhesive forming polymer also contained about 0.5 parts per hundred (pph) (based on polymer solids) of Irgacure 184 (available from BASF (Florham Park, N.J.). The wet hand spread was dried for about 12-15 minutes in a ventilated oven set at 70 degrees C. The adhesive was not UV cured at this stage and thus had no gel. However, if desired, it can be UV cured at some later stage.

The tan delta value at 50 degrees C. was 1.59. The tan delta at 100 degrees C. was 10.50. The adhesive failed the adhesive creep test (i.e. it slipped off the test panel).

### Adhesive 2

A 60/30/7/3 (weight %) 2-ethylhexylacrylate/n-butylacrylate/acrylamide/2-hydroxypropyl acrylate copolymer having an average of 2.91 isocyanatopropyl methacrylate (Karenz MOI available from Show Denko, Japan) groups per chain (already reacted with hydroxy groups of the copolymer using the isocyanate group) and Mw (weight average molecular weight as measured by GPC against a polystyrene standard) of about 219,000 Dalton was solvent coated on a 3 mil siliconized release liner (RF02N from SKC Haas, Korea) using a notch bar set-up. This adhesive forming polymer also contained about 0.5 pph (on polymer solids) of Irgacure 184 (available from BASF (Florham Park, N.J.). The wet hand spread was dried for about 12-15 minutes in a ventilated oven set at 70 degrees C. The adhesive was not UV cured at this stage and thus had no gel. However, if desired, it can be UV cured at some later stage.

The tan delta value at 50 degrees C. was 0.85. The tan delta at 100 degrees C. was 3.0. The adhesive showed significant creep as it was barely hanging on to the stainless steel panel (i.e. it almost slipped off the test panel).

### Adhesive 3

A 40/40/5/15 (weight %) 2-ethylhexylacrylate/n-butylacrylate/acrylamide/2-hydroxyethylacrylate was polymerized at 60% solids in methylethylketone using 0.15 pph Vazo 67 (DuPont, Wilmington, Del.) as the thermal initiator. A weight average molecular weight Mw (as measured by GPC against a polystyrene standard) of about 365,000 Dalton was measured for this material. After cooling the polymer was functionalized with 0.2 pph (based on polymer solids) of isocyanatopropyl methacrylate (Karenz MOI available from Show Denko, Japan). This solution was compounded with 5 pph (based on polymer solids) of CN 983 urethane diacrylate (Sartomer Americas, King of Prussia Pa.) and 0.5 pph (on polymer solids) of Irgacure 184 (available from BASF (Florham Park, N.J.). The material was solvent coated on a 3 mil siliconized release liner (RF02N from SKC Haas, Korea) using a notch bar set-up. The wet hand spread was dried for about 12-15 minutes in a ventilated oven set at 70 degrees C. The adhesive was not UV cured at this stage and thus had no gel. However, if desired, it can be UV cured at some later stage.

The tan delta value at 50 degrees C. was 0.50. The tan delta at 100 degrees C. was 1.00. Creep was not tested.

### Adhesive 4

An acrylic syrup was prepared from an initial mixture that contained isooctylacrylate (87.5 parts), acrylic acid (12.5 parts), and 2,2-dimethoxy-2-phenyl acetophenone initiator (0.04 parts by weight based on the 100 parts of the combined two monomers). This initial mixture was partially polymerized by exposing it to UVA radiation under nitrogen atmosphere until the Brookfield viscosity was between 1000 and 3000 centipoise, so it is coatable and does not run of the liner. Following partial polymerization, 1,6-hexane diol diacrylate (0.06 pph on solids) and additional 2,2-dimethoxy-2-phenyl acetophenone initiator (0.2 pph) were added to the syrup. The mixture was mixed thoroughly and a layer of the syrup with a wet thickness of 50 micrometers was coated between two polyethylene phthalate films treated with a silicone release layer and this sandwich was exposed to low intensity UVA light for the full polymerization process to complete (UVA dose of about 900 mJ/cm2). This adhesive was crosslinked and thus no molecular weight could be measured.

The tan delta value at 50 degrees C. was 0.4. The tan delta at 100 degrees C. was 0.3. The adhesive showed no displacement in the creep test (i.e. did not move from its original position).

### Adhesive 5

An acrylic syrup was prepared from an initial mixture that contained isooctylacrylate (87.5 parts), acrylic acid (12.5 parts), and 2,2-dimethoxy-2-phenyl acetophenone initiator (0.04 parts by weight based on 100 parts of the combined two monomers). This initial mixture was partially polymerized by exposing it to UVA radiation under nitrogen atmosphere until the Brookfield viscosity was between 1000 and 3000 centipoise. Following partial polymerization additional 2,2-dimethoxy-2-phenyl acetophenone initiator (0.2 pph) was added to the syrup. The mixture was mixed thoroughly and a layer of the syrup with a wet thickness of 50 micrometers was coated between two polyethylene phthalate films treated with a silicone release layer and this sandwich was exposed to low intensity UVA light for the full polymerization process to complete (UVA dose of about 900 mJ/cm2).

To get an idea about the molecular weight of this polymer, an inherent viscosity was measured at room temperature using a concentration of 0.2% by weight in ethyl acetate. The room temperature inherent viscosity was about 2.8 dl/g. The corresponding weight average molecular weight Mw as measured by GPC against a polystyrene standard was estimated to be well over 1,000,000.

The tan delta value at 50 degrees C. was 0.59. The tan delta at 100 degrees C. was 0.71. Creep was not tested.

Testing Results

Table 1 below summarizes the different sample constructions that were made and how they fared for initial lamination quality. The objective for this comparison was both to provide bubble free step coverage and also to minimize the ink-step response slope. Those sample types exhibiting bubble formation or lamination failures were not evaluated with the Web distortion test; those which resulted in bubble free laminations were measured.

TABLE 1

| | | Slip layer | | | Slip layer | | | |
|---|---|---|---|---|---|---|---|---|
| Exam. | Film layer | (film side) | Cure | Core layer | (coupon side) | Cure | A Slope measures | B Slope measures |
| Ex 1 | 4 mil COP | 2 mil, Adh1 | N | CEF 2804 | none | NA. | 4583, 3916, 3333 | 4833, 4833, 4333 |
| Ex 2 | 4 mil COP | none | NA. | CEF 2806 | none | NA. | 11583, 10166, 10466 | 12000, 11166, 10666 |
| Ex 3 | 4 mil COP | none | NA.. | CEF 2804 | 2 mil, Adh1 | N | 4916, 3916, 2833 | 6166, 5000, 3666 |
| Ex 4 | 2 mil PET | 8146-2 | NA. | 2 mil Adh2 | 8146-2 | NA. | 15083, 11689, 11749 | 15082, 12754, 13416 |
| Ex 5 | 2 mil PET | 2 mil, Adh1 | N | 8146-2 | 2 mil, Adh1 | N | 10583, 9160, 9000 | 11570, 10833, 10813 |
| Ex 6 | 2 mil PET | 2 mil, Adh2 | N | 8146-2 | 2 mil, Adh2 | N | 10167, 8833, 8500 | 8000, 8878, 6000 |
| Ex 7 | 2 mil PET | 2 mil, Adh2 | 500 mJ | 8146-2 | 2 mil, Adh2 | 500 mJ | 10833, 9500, 9666 | 11667, 12493, 13667 |
| Ex 8 | 2 mil PET | 2 mil, Adh2 | 1000 mJ | 8146-2 | 2 mil, Adh2 | 1000 mJ | 13102, 13083, 12167 | 11883, 11667, 11833 |
| Ex 9 | 2 mil PET | 2 mil, Adh3 | N | 8146-2 | 2 mil, Adh3 | N | 13333, 13166, 11500 | 10833, 10250, 9946 |
| Ex 10 | 2 mil PET | 2 mil, Adh3 | 1000 mJ | 8146-2 | 2 mil, Adh3 | 1000 mJ | 21914, 20546, 20116 | 13666, 14333, 16083 |
| Ex 11 | 2 mil PET | 2 mil, Adh3 | 3000 mJ | 8146-2 | 2 mil, Adh3 | 3000 mJ | 19705, 19689, 21506 | 16500, 15000, 15590 |
| Ex 12 | 2 mil PET | 2 mil, Adh4 | N | 8146-2 | 2 mil, Adh4 | N | 20629, 21514, 22191 | 20407, 13856, 14750 |
| Ex 13 | 2 mil PET | 2 mil Adh 5 | N | 8146-2 | 2 mil Adh 5 | N | 12667, 11584, 11917 | 14878, 15762, 15742 |

As can be seen in the data tabled above, going to a thinner (2 mil) polyester—and thus more compliant film—seemed to worsen the unevenness around the ink step response. This is reflected in the generally higher measured slopes for these cases. In contrast, the stiffer 4 mil (100 micron) thick COP showed less rebound and unevenness once the lamination force was removed. The 150 micron thick CEF2806 performed quite well but the 50 micron slip layer/100 micron CEF2804 showed a much lower distortion as reflected in the significantly lower slope values. Table 2 below shows the same examples with the tan delta values for each of the slip layers included.

TABLE 2
examples comparison by tan delta measures for slip layers.

| | | | tan delta | | | tan delta | | |
|---|---|---|---|---|---|---|---|---|
| | | Slip layer | 50° C./ | | Slip layer | 50° C./ | | |
| Exam. | Film layer | (film side) | 100° C. | Core layer | (coupon side) | 100° C. | A Slope measures | B Slope measures |
| Ex 1 | 4 mil COP | 2 mil, Adh1 | 1.59/10.50 | CEF 2804 | none | | 4583, 3916, 3333 | 4833, 4833, 4333 |
| Ex 2 | 4 mil COP | none | | CEF 2806 | none | | 11583, 10166, 10466 | 12000, 11166, 10666 |
| Ex 3 | 4 mil COP | none | | CEF 2804 | 2 mil, Adh1 | 1.59/10.50 | 4916, 3916, 2833 | 6166, 5000, 3666 |
| Ex 4 | 2 mil PET | 8146-2 | | 2 mil Adh2 | 8146-2 | | 15083, 11689, 11749 | 15082, 12754, 13416 |
| Ex 5 | 2 mil PET | 2 mil, Adh1 | 1.59/10.50 | 8146-2 | 2 mil, Adh1 | 1.59/10.50 | 10583, 9160, 9000 | 11570, 10833, 10813 |
| Ex 6 | 2 mil PET | 2 mil, Adh2 | 0.85/3.0 | 8146-2 | 2 mil, Adh2 | 0.85/3.0 | 10167, 8833, 8500 | 8000, 8878, 6000 |
| Ex 7 | 2 mil PET | 2 mil, Adh2 | 0.76/1.5 | 8146-2 | 2 mil, Adh2 | 0.76/1.5 | 10833, 9500, 9666 | 11667, 12493, 13667 |
| Ex 8 | 2 mil PET | 2 mil, Adh2 | 0.51/0.79 | 8146-2 | 2 mil, Adh2 | 0.51/0.79 | 13102, 13083, 12167 | 11883, 11667, 11833 |
| Ex 9 | 2 mil PET | 2 mil, Adh3 | 0.50/1.0 | 8146-2 | 2 mil, Adh3 | 0.50/1.0 | 13333, 13166, 11500 | 10833, 10250, 9946 |
| Ex 10 | 2 mil PET | 2 mil, Adh3 | 0.39/0.26 | 8146-2 | 2 mil, Adh3 | 0.39/0.26 | 21914, 20546, 20116 | 13666, 14333, 16083 |
| Ex 11 | 2 mil PET | 2 mil, Adh3 | 0.37/0.23 | 8146-2 | 2 mil, Adh3 | 0.37/0.23 | 19705, 19689, 21506 | 16500, 15000, 15590 |
| Ex 12 | 2 mil PET | 2 mil, Adh4 | 0.40/0.30 | 8146-2 | 2 mil, Adh4 | 0.40/0.30 | 20629, 21514, 22191 | 20407, 13856, 14750 |
| Ex 13 | 2 mil PET | 2 mil, Adh5 | 0.59/0.71 | 8146-2 | 2 mil, Adh5 | 0.59/0.71 | 12667, 11584, 11917 | 14878, 15762, 15742 |

What is claimed is:

1. An article comprising:
a core film layer having a first surface and a second surface, wherein the core film layer is optically clear or optically active; and
a first curable adhesive layer positioned adjacent the first surface of the core layer,
wherein the first curable adhesive layer is optically clear, and
wherein the first curable adhesive layer has a tan delta of at least 0.8 at a temperature of 100° C. at 1 Hz.

2. The article of claim 1, further comprising a substrate positioned adjacent the first curable adhesive layer.

3. The article of claim 1, wherein the core film layer is adhesive.

4. The article of claim 1, wherein the core film layer is a plastic film used for displays, including a touch sensor, a polarizer, a protective film.

5. The article of claim 1, wherein the curable adhesive layer is not crosslinked.

6. The article of claim 1, wherein the curable adhesive layer in its uncured state has a creep of 2 cm or more when tested at 60 degrees C. on a stainless steel back panel using a 1.5 cm×2 cm overlap and a load of 500 g.

7. The article of claim 1, wherein the first curable adhesive layer comprises one of a pressure-sensitive optically clear adhesive and a heat activated optically clear adhesive.

8. The article of claim 6, wherein the first curable adhesive layer has a creep of 2 cm or more at a temperature of less than about 85° C.

9. The article of claim 1, further comprising a second curable adhesive layer positioned adjacent the second surface of the core film layer, wherein the second curable adhesive layer is optically clear and wherein the second curable adhesive layer has a tan delta of at least 0.8 at a temperature of 100° C. at 1 Hz.

10. The article of claim 9, wherein the first and second curable adhesive layers have the same composition.

11. The article of claim 9, wherein the first and second curable adhesive layers have different compositions.

12. The article of claim 1, wherein the first curable adhesive layer has a molecular weight of between 50 kg/mol and 500 kg/mol.

13. The article of claim 11, wherein the first curable adhesive layer has a molecular weight of between 50 kg/mol and 400 kg/mol.

14. The article of claim 1, wherein the first curable adhesive layer has a tan delta of at least 0.9 at a temperature of 100° C. at 1 Hz.

15. The article of claim 13, wherein the first curable adhesive layer has a tan delta of at least 1 at a temperature of 100° C. at 1 Hz.
